(19) United States
(12) Patent Application Publication
(10) Pub. No.: US 2021/0150632 A1
(43) Pub. Date: May 20, 2021

(54) SYSTEMS AND METHODS FOR AUTHENTICATED VOUCHER DISTRIBUTION USING BLOCKCHAIN

(71) Applicant: WILLPORTTRUST LLC, San Diego, CA (US)

(72) Inventor: Doris H. SCHWARTZ, San Diego, CA (US)

(73) Assignee: WILLPORTTRUST LLC, San Diego, CA (US)

(21) Appl. No.: 17/097,131

(22) Filed: Nov. 13, 2020

Related U.S. Application Data
(60) Provisional application No. 62/939,181, filed on Nov. 22, 2019.
(60) Provisional application No. 62/937,127, filed on Nov. 18, 2019.

(51) Int. Cl. G06Q 40/00; H04L 9/32

(52) U.S. Cl. CPC G06Q 40/12; H04L 9/32

(57) ABSTRACT

Disclosed are systems and methods that includes at least one hardware processor and a memory storing instructions that, when executed by the at least one hardware processor, cause the at least one hardware processor to perform operations including receiving an initiation request associated with a voucher to be transferred from a first user and a second user, wherein the voucher is initiated by the first user, initiating a voucher and transmitting the voucher to the second user, and verifying an identification of the second user; and processing the voucher.

### CROSS-REFERENCE

This application claims the benefit of U.S. Provisional Application No. 62/937,127, filed Nov. 18, 2019, entitled Authenticated Voucher for Distribution of Funds Upon Occurrence of a Triggering Event Using Blockchain, and U.S. Provisional Application No. 62/939,181, filed Nov. 22, 2019, entitled Authenticated Voucher for Distribution of Funds Using Blockchain, which applications are incorporated herein in their entirety by reference.

This application is related to U.S. Utility application Ser. No. ______, filed concurrently herewith entitled Systems and Methods for Authenticated Trust Distribution Using Blockchain (Attorney Ref. W5370.2121 US [CAO/sf]) and U.S. Utility application Ser. No. ______, filed concurrently herewith entitled Systems and Methods for Authenticated Distribution Upon Occurrence of a Triggering Event Using Blockchain (Attorney Ref. W5370.2131 US [CAO/sf]) both of which claim ultimate priority to U.S. Provisional Application No. 62/937,127, filed Nov. 18, 2019, entitled Authenticated Voucher for Distribution of Funds Upon Occurrence of a Triggering Event Using Blockchain, which applications are incorporated herein in their entirety by reference,

### BACKGROUND

Young people today are facing a savings deficit. In fact, 67% of young millennials (between 18 and 24) and 61% of older millennials (between 25 and 34) have less than $1,000 in savings. Lack of savings and lack of developing good habits related to savings early in life can have a long-term impact on wealth. Those who don't save are unlikely to be wealthy in the future. Young people spend their money on food delivery, travel and their social life. This youth saving trend causes concern for parents, grandparents, aunts and uncles.

Even if some money is directed towards savings, young people often do not have a relationship with an advisor who can guide them in their investing strategy to ensure they are on a path for success later in life.

Additionally, in some relationships one person takes on the primary role of managing the finances. In the event of an illness the spouse or partner may feel ill-equipped to take over the responsibility for managing the finances.

What is needed is a way to provide funds to a young person upon the occurrence of an event that establishes an initial relationship for a minimum period of time with an advisor. What is also needed is a way to provide restricted funds to a person who could benefit from coaching and oversight of financial management.

### SUMMARY

Disclosed are systems and methods for administering a voucher. The system provides for the electronic transfer of a voucher followed by the transfer of money at a present or future date, using a comprehensive and secure time forward delivery system. The systems and methods are configurable to be integratable into a financial or insurance institution's existing digital delivery framework or configurable to operate as a stand-alone platform. Integrity of the voucher system can be provided with the use of, for example, blockchain and/or biometric data.

An aspect of the disclosure is directed to blockchain voucher systems. Systems comprise: at least one hardware processor; and a memory storing instructions that, when executed by the at least one hardware processor, causes the at least one hardware processor to perform operations in a networked computing environment comprising: receiving a request to create a voucher from a requestor; creating a voucher blockchain; obtaining recipient information from the requestor; appending the recipient information to a voucher blockchain; obtaining one or more voucher source information from the requestor; appending the one or more voucher source information to the voucher blockchain; obtaining an advisor information from the requestor; appending the advisor information to the voucher blockchain; generating the voucher wherein the voucher comprises a control logic configured to control access to the voucher based on obtaining verification of the recipient, instructions from the recipient, and instructions from the advisor and the control logic is executed using the hardware processor configured to receive a first instruction from the recipient to open an account and a second instruction from the advisor to open an account; and appending the voucher to the voucher blockchain. The systems can include one or more instructions comprising: obtaining a marital status from the requestor; obtaining spousal information from the requestor; obtaining spousal agreement from a spouse; confirming the marital status; generating a marital status completion block; and appending the marital status completion block to the voucher blockchain. Additionally, the systems can include one or more instructions comprising: obtaining a personalization input from the requestor for the one or more recipients; generating a personalization completion block; and uploading the personalization completion block to the voucher blockchain. In still other configurations, the systems can include one or more instructions comprising: creating a voucher agreement; creating an account set-up form; creating a management agreement; creating an account transfer form; creating a margin agreement; creating an options agreement; creating a money movement agreement; generating a voucher documents completion block containing the one or more created forms ad agreements; and appending the voucher documents completion block to the voucher blockchain. The system can also be configured to generate a unique hash value for each of the documents reviewed and signed based on a secure hash algorithm in real time and store each unique hash value on the voucher blockchain. Additional instructions can include notifying the recipient of the voucher; registering the voucher by the recipient; obtaining an approval of redemption documents from the recipient; generating a voucher delivery completion block; and appending the voucher delivery completion block to the voucher blockchain. Redemption documents can include one or more of: recipient account set-up; management agreement; account transfer form; margin agreement; options agreement; and move money agreement. Instructions can further comprise one or more of: providing an instruction for a coaching amount; providing an instruction for coaching terms; generating a coaching voucher delivery block; and appending the coaching voucher delivery completion block to the voucher blockchain. Moreover, the instructions can also further comprise one or more of: analyzing an instruction from a recipient; providing the recipient feedback on the instruction; generating a coaching transaction block and appending the coaching transaction block to the voucher blockchain. The system is also configuration to provide recipient feedback at a plurality of times. The system can also be configure to obtain one or more verification contact information for the recipient; and/or appending the verification contact information to the voucher blockchain.

Another aspect of the disclosure is directed to computer-implemented methods for account creation in a networked computing environment. The method comprise: receiving a request to create a voucher from a requestor; creating a voucher blockchain; obtaining recipient information from the requestor; appending the recipient information to a voucher blockchain; obtaining one or more verification contact information for the recipient; appending the one or more voucher source information to the voucher blockchain; obtaining an advisor information from the requestor; appending the advisor information to the voucher blockchain; generating the voucher wherein the voucher comprises a control logic configured to control access to the voucher based on obtaining verification of the recipient, instructions from the recipient, and instructions from the advisor and the control logic is executed using the hardware processor configured to receive a first instruction from the recipient to open an account and a second instruction from the advisor to open an account; and appending the voucher to the voucher blockchain. The methods can include one or more instructions comprising: obtaining a marital status from the requestor; obtaining spousal information from the requestor; obtaining spousal agreement from a spouse; confirming the marital status; generating a marital status completion block; and appending the marital status completion block to the voucher blockchain. Additionally, the methods can include one or more instructions comprising: obtaining a personalization input from the requestor for the one or more recipients; generating a personalization completion block; and uploading the personalization completion block to the voucher blockchain. In still other configurations, the methods can include one or more instructions comprising: creating a voucher agreement; creating an account set-up form; creating a management agreement; creating an account transfer form; creating a margin agreement; creating an options agreement; creating a money movement agreement; generating a voucher documents completion block containing the one or more created forms ad agreements; and appending the voucher documents completion block to the voucher blockchain. The system can also be configured to generate a unique hash value for each of the documents reviewed and signed based on a secure hash algorithm in real time and store each unique hash value on the voucher blockchain. Additional instructions can include notifying the recipient of the voucher; registering the voucher by the recipient; obtaining an approval of redemption documents from the recipient; generating a voucher delivery completion block; and appending the voucher delivery completion block to the voucher blockchain. Redemption documents can include one or more of: recipient account set-up; management agreement; account transfer form; margin agreement; options agreement; and move money agreement. Instructions can further comprise one or more of: providing an instruction for a coaching amount; providing an instruction for coaching terms; generating a coaching voucher delivery block; and appending the coaching voucher delivery completion block to the voucher blockchain. Moreover, the instructions can also further comprise one or more of: analyzing an instruction from a recipient; providing the recipient feedback on the instruction; generating a coaching transaction block and appending the coaching transaction block to the voucher blockchain. The system is also configuration to provide recipient feedback at a plurality of times. The system can also be configure to obtain one or more verification contact information for the recipient; and/or appending the verification contact information to the voucher blockchain.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

U.S. Pat. No. 5,878,140 A to Chaum issued Mar. 2, 1999 for Limited-Traceability Systems;

U.S. Pat. No. 9,342,831 B1 to Davis issued May 17, 2016 for Facilitating Same Day Payment Transactions;

U.S. Pat. No. 9,342,741 B2 to Amtrup issued May 17, 2016, for Systems, Methods and Computer Program Products for Determining Document Validity;

U.S. Pat. No. 10,142,347 B2 to Kurian issued Nov. 27, 2018, for System for Centralized Control of Secure Access to Process Data Networks;

U.S. Pat. No. 10,164,779 B2 to Uhr et al., issued Dec. 25, 2018, for System for Issuing Public Certificate on Basis of Block chain, and Method for Issuing Public Certificate on Basis of Block chain by Using Same;

U.S. Pat. No. 10,331,868 B2 to Park issued Jun. 25, 2019, for User Authentication Method and System Using Variable Keypad and Biometric Identification;

U.S. Pat. No. 10,332,115 B2 to Donovan et al., issued Jun. 25, 2019, for Systems and Methods for Processing Metadata Statements in Payment Flows;

U.S. Pat. No. 10,798,094 B2 to Wei issued Oct. 6, 2020, for Blockchain-based account management;

U.S. Pat. No. 10,798,180 B1 to Gracey et al. issued Oct. 6, 2020 for Systems And Methods For Optimizing Information Collaboration; and

US 2019/0005470 A1 to Uhr, et al., published Jan. 3, 2019, for Accredited Certificate Issuance System Based on Block chain and Accredited Certificate Issuance Method Based on Block chain Using Same, and Accredited Certificate Authentication System Based on Block chain and Accredited Certificate Authentication Method Based on Block chain Using Same.

### BRIEF DESCRIPTION OF THE DRAWINGS

The novel features of the invention are set forth with particularity in the claims. A better understanding of the features and advantages of the present invention will be obtained by reference to the following detailed description that sets forth illustrative embodiments, in which the principles of the invention are utilized, and the accompanying drawings of which:

FIG. 1 is a block diagram illustrating a blockchain system environment suitable for use with the disclosed voucher system;

FIGS. 2A-2G are flow diagrams illustrating a gift voucher creation process;

FIGS. 3A-3B are flow diagrams illustrating a gift voucher delivery process;

FIGS. 4A-4C are flow diagrams illustrating a gift voucher redemption process;

FIGS. 5A-5G are flow diagrams illustrating a coaching voucher creation process;

FIGS. 6A-6B are flow diagrams illustrating a coaching voucher delivery process;

FIGS. 7A-7C are flow diagrams illustrating a coaching voucher redemption process; and

FIG. 8 is a flow diagram illustrating a coaching process between the user, the advisor and the recipient.

### DETAILED DESCRIPTION

### I. Blockchain Process

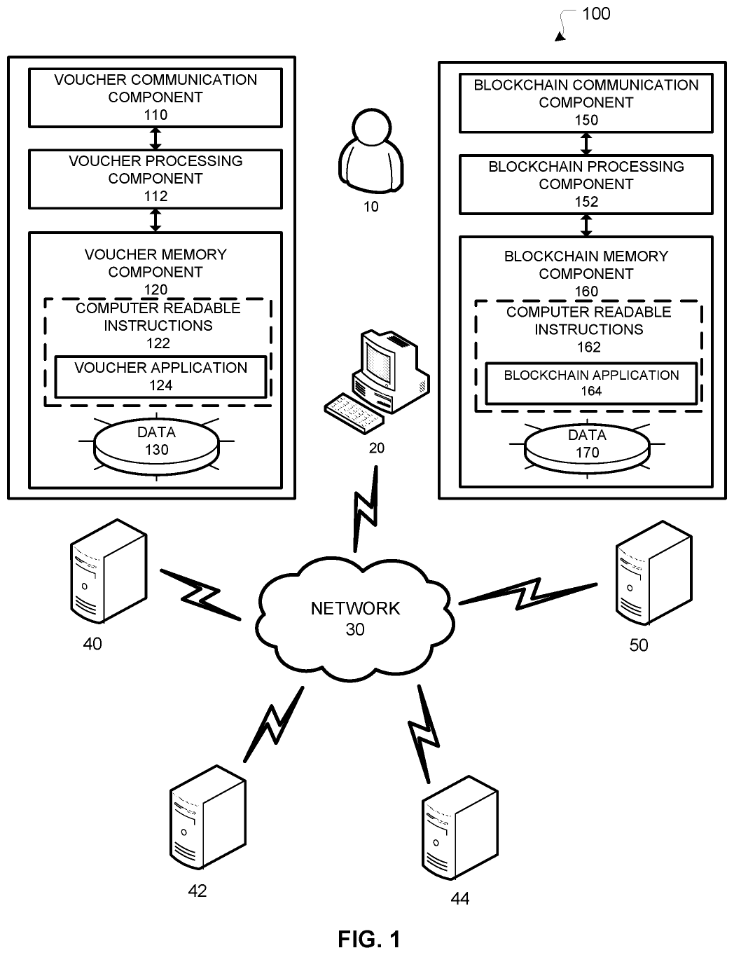

Turning now to FIG. 1, a blockchain and voucher system 100 generally comprises one or more blockchain communication components 150, one or more blockchain processing components 152, and one or more blockchain memory components 160. The one or more blockchain processing components 152 are operatively coupled to the one or more blockchain communication components 150 and the one or more blockchain memory components 160. As will be appreciated by those skilled in the art, processing components and processors generally includes circuitry used for implementing the communication and/or logic functions of a particular system. For example, a blockchain processing component 152 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more blockchain processing components 152 may include functionality to operate one or more software programs based on blockchain computer-readable instructions 162 thereof, which may be stored in the one or more blockchain memory components 160.

The one or more blockchain processing components 152 use the one or more blockchain communication components 150 to communicate with the network 30 and other components on the network 30, such as, but not limited to, the user computer systems 20, first entity systems 40, second entity systems 42, Nth entity systems 44, or other like systems. As such, the one or more blockchain communication components 150 generally comprise a wireless transceiver, modem, server, electrical connection, electrical circuit, or other component for electronically communicating with other components on the network 30. The one or more blockchain communication components 150 may further include an interface that accepts one or more network interface cards, ports for connection of network components, Universal Serial Bus (USB) connectors and the like.

A blockchain can be comprised of one or more blocks (digital information) and/or sub-blockchains which can also be comprised of one or more blocks, in a chain (database). Blocks store information about transactions. A single block on a blockchain can store as much as 1 MB of data (e.g., a few thousand transactions per block). Once a process is completed, the block can be configured so that it cannot be written to following completion. Data, e.g. event records, blocks and/or blockchains (such as sub-blockchains) can be appended to a blockchain. The blockchain is a distributed ledger system on a peer-to-peer network that operates without utilizing a centralized transaction authority. The blockchain distributed ledger provides transparency and immutability. Changes to the blockchain ledger are viewable by all permissioned participants and the corresponding transactions cannot be altered or deleted. Additionally, the system is configurable to generate a unique hash value for each of the block entries, such as documents reviewed and signed, based on a secure hash algorithm in real time and store each unique hash value on the voucher blockchain.

As further illustrated in FIG. 1, the blockchain system 50 comprises blockchain computer-readable instructions 162 stored in the blockchain memory component 160, which in one embodiment includes the blockchain computer-readable instructions 162 of the blockchain application 164. In some embodiments, the one or more blockchain memory components 160 include one or more blockchain data stores 170 for storing data related to the blockchain systems 50, including, but not limited to, data created, accessed, and/or used by the blockchain application 164.

The blockchain systems 50, and the components therein, may be one or more private blockchains, one or more public blockchains, and/or one or more hybrid blockchains. Moreover, the blockchain systems 50 may be located in or associated with the other systems described herein.

Users 10 may access the blockchain application 164 on the one or more blockchain systems 50, or a portion thereof stored on other systems (e.g., a portion of the blockchain application 164 stored on the user computer systems 20 or first entity systems 40, second entity system 42 or nth entity system 44), or through other applications, through a user computer system 20. The user computer system 20 may be a desktop, laptop, tablet, mobile device (e.g., smartphone device, or other mobile device), or any other type of computer that generally comprises one or more voucher communication components 110, one or more voucher processing components 112, and one or more voucher memory components 120.

The one or more voucher processing components 112 are operatively coupled to the one or more voucher communication components 110, and the one or more voucher memory components 120. The one or more voucher processing components 112 use the one or more voucher communication components 110 to communicate with the network 30 and other components on the network 30, such as, but not limited to, the blockchain systems 50, the first entity systems 40, the second entity systems 42, the Nth entity systems 44, or other systems. As such, the one or more voucher communication components 110 generally comprise a wireless transceiver, modem, server, electrical connection, or other component for electronically communicating with other components on the network 30. The one or more blockchain communication components 150 may further include an interface that accepts one or more network interface cards, ports for connection of network components, Universal Serial Bus (USB) connectors and the like. Moreover, the one or more voucher communication components 110 may include a keypad, keyboard, touch-screen, touchpad, microphone, mouse, joystick, other pointer component, button, soft key, and/or other input/output component(s) for communicating with the users 10.

As illustrated in FIG. 1, the user computer systems 20 may have a voucher computer-readable instructions 122 stored in the one or more voucher memory components 120, which in one embodiment includes the voucher computer-readable instructions 122 of voucher applications 124, such as dedicated applications (e.g., apps, applet, or the like), portions of dedicated applications, web browser or other apps that allow access to applications located on other systems, or the like. As previously discussed, the blockchain application 164, or a portion thereof, may be stored on each of the user computer systems 20.

As illustrated in FIG. 1, the first entity systems 40, the second entity systems 42, the Nth entity systems 44, or other systems are operatively coupled to the blockchain systems 50 and/or user computer systems 20, through the network 30. These systems have components that are the same as or similar to the components described with respect to the blockchain systems 50 and/or user computer systems 20 (e.g., one or more communication components, one or more processing components, and one or more memory devices with computer-readable instructions of one or more applications, one or more datastores, or the like). Thus, the first entity systems 40, the second entity systems 42, the Nth entity systems 44, or other systems communicate with the blockchain systems 50, the user computer systems 20, and/or each other in same or similar way as previously described with respect to the blockchain systems 50 and/or the user computer systems 20. The first entity systems 40, second entity systems 42, Nth entity systems 44 may be made up of one or more user computer systems 20, one or more of the blockchain systems 50, or other entity systems that act as nodes which are utilized to store, disseminate, and/or validate event information for events within the blockchain. It should be further understood that the blockchain systems 50 may be separate systems and/or a part of each user computer system 20, and/or first entity systems 40, second entity systems 42, Nth entity systems 44.

Rather than utilizing a centralized database to access, view, store, disseminate, and/or validate information, the present voucher system utilizes a decentralized blockchain configuration or architecture to order to allow users 10 to access, view, store, disseminate, and/or validate information, or take another action related to an event. Such a decentralized blockchain configuration ensures accurate mapping and validation of event information, and provides a secured network over which information may be validated. Accordingly, blockchain configurations may be utilized with respect to any type of information, such as, but not limited to maintaining an accurate ledger of information, such as resource transfer information (e.g., transaction, asset transfer, sale, or other like transfer of value information), personal information, credit history information, or the like, in order to provide validation, such as validation of resource transfers, or access to personal information, or the like.

As will be appreciated by those skilled in the art, a blockchain, or “blockchain,” is a distributed database that maintains a list of data records, the security of which is enhanced by the distributed nature of the blockchain. A blockchain typically includes several nodes, which may be one or more entities, systems within an entity, machines, computers, databases, data stores, or the like operably connected with one another. For example, the various systems described with respect to FIG. 1, or systems within the systems described with respect to FIG. 1 may be nodes. In some aspects of the disclosure, an entity may be a node of a blockchain, and internal users or external users 10 may access the entity systems in order to take actions with respect to an event. In other aspects of the various systems, any nodes may or may not be grouped together and associated with the entity. Each of the nodes or multiple nodes can be maintained by different entities, or components within an entity, and as such different systems within an entity or between entities may act as nodes.

A blockchain typically works without a central repository or single administrator. However, a network of nodes within a single entity or group of entities may together serve as a central repository or single administrator that can control access to the blockchain that is associated with a plurality of different nodes. One application of a blockchain is the public ledger of resource transfers for cryptocurrencies, such as used in bitcoin. In this use of a blockchain, the data records recorded in the blockchain are enforced cryptographically and stored on the nodes of the blockchain within a voucher system. The distributed blockchain network disclosed herein can have at least one private blockchain portion and in some cases a public blockchain portion. The system allows users to take actions (e.g, accessing, viewing, storing, disseminating, validating, or the like) with respect to the vouchers. Each block is a time-stamped series of an immutable record of data that is managed by cluster of computers not owned by any single entity. Each of these blocks of data (i.e. block) are secured and bound to each other using cryptographic principles (i.e. chain). Portions of the distributed ledger can form a smart contract which includes an offer, acceptance and consideration.

A blockchain provides numerous advantages over traditional databases. For example, with respect to utilizing a blockchain for resource transfer information, a large number of nodes of a blockchain may reach a consensus regarding the validity of a resource transfer contained on a decentralized resource transfer ledger. Similarly, when multiple versions of a document or resource transfer exits on the ledger, multiple nodes can converge on the most up-to-date version of the resource transfer. For example, in the case of a virtual currency resource transfer, any node within the blockchain that stores or validates the resource transfer, can determine within a level of certainty whether the resource transfer can take place and become final by confirming that no conflicting resource transfers (i.e., the same currency unit has not already been spent) are confirmed by the blockchain elsewhere on other nodes.

The blockchain typically has two primary types of records. The first type is the event type (e.g., resource transfer type, document type, or the like), which consists of the actual data stored in the blockchain. The second type is the block type, which are records that confirm when and in what sequence certain events (e.g., resource transfers, or the like) became recorded as part of the blockchain. Events (e.g., resource transfers, or the like) are created by participants using the blockchain in its normal course of business, (for example, when someone sends cryptocurrency to another person), blocks are created by users known as “miners” who use specialized software/equipment to create the blocks for the event. Users of the blockchain create blocks for the events (e.g., resource transfers, or the like), which are passed around to various nodes of the blockchain. A “valid” resource transfer is one that can be validated based on a set of rules that are defined by the particular system implementing the blockchain.

Blockchains are typically decentralized. A distributed ledger (e.g., a decentralized ledger) is maintained on multiple nodes of the blockchain. One node in the blockchain may have a complete or partial copy of the entire ledger or set of events (e.g., resource transfers, or the like) and/or blocks on the blockchain. Events (e.g., resource transfers, or the like) are initiated at a node of a blockchain and communicated to the various other nodes of the blockchain. Any of the nodes, or users of the nodes, which have access to the blockchain to validate an event, add the event to its copy of the blockchain, and/or broadcast the event (e.g., resource transfer or the like) its validation (in the form of a block) and/or other data to other nodes. This other data may include time-stamping.

Various other applications of blockchains may be utilized for the voucher application. These include contract execution, analyst reporting, financial reporting, synchronous/asynchronous communication, controlling access to or dissemination of timeline, personal, and/or financial data and even a general purpose deployment of decentralized applications. As such, blockchains may be utilized to access, view, store, create, disseminate, and/or validate any type of event information, or take any other type of action with respect to event information associated with an event.

In various aspects, the blockchain may be configured with a set of rules (otherwise described herein as “limits”) to dictate what actions may be taken by users and/or nodes for various events, how information may be accessed, created, stored, disseminated, and/or validated, and/or how the network communicates information throughout the one or more blockchains across the nodes of various entities associated with the nodes (e.g., supports the nodes on the entity systems). In some aspects, the rules dictate that an originating node (i.e., a node through which a resource transfer was initiated) must approve all actions for events mapped to that node. In some aspects, the rules dictate that some or all actions for events may be approved by one or more validator nodes without further input from the originating node. In some such cases, the rules dictate that additional information is needed in determining whether an action for an event should be approved. In other aspects, the validating node must reach out to the originating node in certain situations as dictated by the rules. For example, if the action for the event, such as validating a resource transfer, is in any way, indicated to be a faulty or invalid (due to some information present on the blockchain), then the rules may dictate that the validating node communicate with the originating node to confirm or deny validation of the event.

In some aspects, the validator may approve the event (e.g., resource transfer, or the like) without communicating with the originating node. In such a case, the validator (or a group or all of validators if multiple or universal validations, respectively, are required by the rules), can approve the action for the event based solely on the information contained in the blockchain. Thus, if an action for an event is requested and a validator receives the action for the event, it can check the actions for the event against its ledger to determine whether an originating node has validated the event. If so, then the validator may approve the action for the event. In this regard, the action for the event may be approved very quickly, and in some cases, in real-time or near real-time.

In various aspects, any of the blockchain nodes may be a validator or a miner that validates events (e.g., resource transfers, or the like). In some aspects, a number of the nodes must validate an event (e.g., resource transfer, or the like) in order for the event to be approved. For example, in one embodiment, two or three nodes must validate the authenticity of the event, or portions thereof, before the event may be approved. As noted above, in some instances, the rules of the blockchain and/or rules specific to particular originating entities or validators dictate that validators cannot approve events without confirming available information (e.g., funds used in a resource transfer). In some cases, the available information is already associated with an alias on the public blockchain, or associated with a customer within an entity controlling a private blockchain, but in other cases, the validator on the blockchain must communicate with the originating entity in order to request approval of the event (e.g., resource transfer, or the like).

In some aspects, the rules may only be changed by the originating node (maintained by an originating entity or entities that control the blockchain) to ensure the validity of a change to a rule. In some cases, particularly in cases where one or more nodes have raised a concern that an event is not valid, the originating node may be contacted for verification of the event.

In various aspects, the event, or information for the event, is stored and executed from one or more systems and is not placed on the public blockchain itself, and instead is located on a private portion of the blockchain. In some aspects, the event, or information for the event, is only stored and executed from a subset of the nodes of the blockchain, which, in some aspects, are synonymous with validator nodes and in other aspects are not synonymous with the validator nodes. In some aspects, placeholder(s) for the event (e.g., resource transfers, or the like) indicating that the event exists and/or a description of the event, is accessible from private blockchains and may be placed on the public blockchain. The placeholder(s) may be identifiers (e.g., characters, or the like) and/or a description of the event. In some cases, the event may be executed only by the designated one or more systems (e.g., on the private blockchain, or on a private portion of a blockchain). Such systems may utilize a key or other security mechanism(s) in order to ensure only certain nodes are allowed access to the information related to the private blockchain portion. In some cases, this configuration may result in additional security instead of placing the event on the public blockchain for any node to execute.

### II. Voucher System Overview

Turning to the disclosed voucher systems, in an initial process a user creates an account within the system. During the account creation process, the user specifies a plan, identifies one or more plan controllers, specifies one or more accounts to be accessed, identifies one or more advisors, identifies one or more recipients. During this process, the system creates a block for the blockchain for this transaction.

The voucher system is a service provider that has a variety of system participants including but not limited to: the account holder (user), the recipient, the beneficiary, the plan controller, the advisor, the spouse, the verification contact, etc.

During the set-up process, the user also indicates a marital status. If the user is married, then information about the spouse is entered into the voucher system and a spousal consent agreement is sent electronically to the spouse. In one configuration, the spouse prints the authorization, signs the authorization in front of a witness or Notary Public, and then returns an electronic copy of the completed document. Return of the electronic copy can occur by any suitable process including, for example, uploading a photo of the signed document via a mobile device. The system can then review the document for legibility to ensure the document appended is the authorization and the information required is present and legible. If the information is not legible, the system can flag the document for human review and/or notify the person uploading the document that the quality of the document is not sufficient. In another configuration, the spouse creates an account with the system and accesses an electronic version of the consent agreement. The spouse is then given the opportunity to accept or reject the agreement. In order to complete the acceptance biometric data, such as a fingerprint, may be required. Thus, for example, in a mobile environment, the spouse would choose accept and then be required to swipe a known finger across the fingerprint sensor embedded in the phone.

Once the user identifies an advisor and indicates a marital status, a notification is sent to the advisor notifying the advisor that the advisor has been identified as the advisor for the user in the voucher system and requesting the advisor confirm or indicate a marital status for the user. In response to the marital status inquiry, the advisor confirms the marital status. In one configuration, for example, the advisor can be presented with an option such as “John Smith—married” with a confirm YES/NO option. In another configuration, the advisor can be required to independently indicate a marital status for the user. Once the advisor indicates the marital status of the user, the voucher system determines if the marital status is correct by either determining that the advisor has indicated a positive confirmation or has entered the same marital status as the user. If the marital status is correct (YES), then the process proceeds to completion. If the marital status is not correct (NO), then the voucher system notifies the user and requests the information be updated.

If the user is unmarried and the advisor confirms that the user in unmarried, then the plan and distribution details are finalized and the plan controller executes the contract. The plan controller can have limited or restricted permissions. Permissions for the plan controller can be set to change upon the occurrence of one or more defined events (e.g., incapacity or death of the user). Once all the components are completed, the plan is finalized and distribution details are completed.

### III. Gift Voucher System Overview

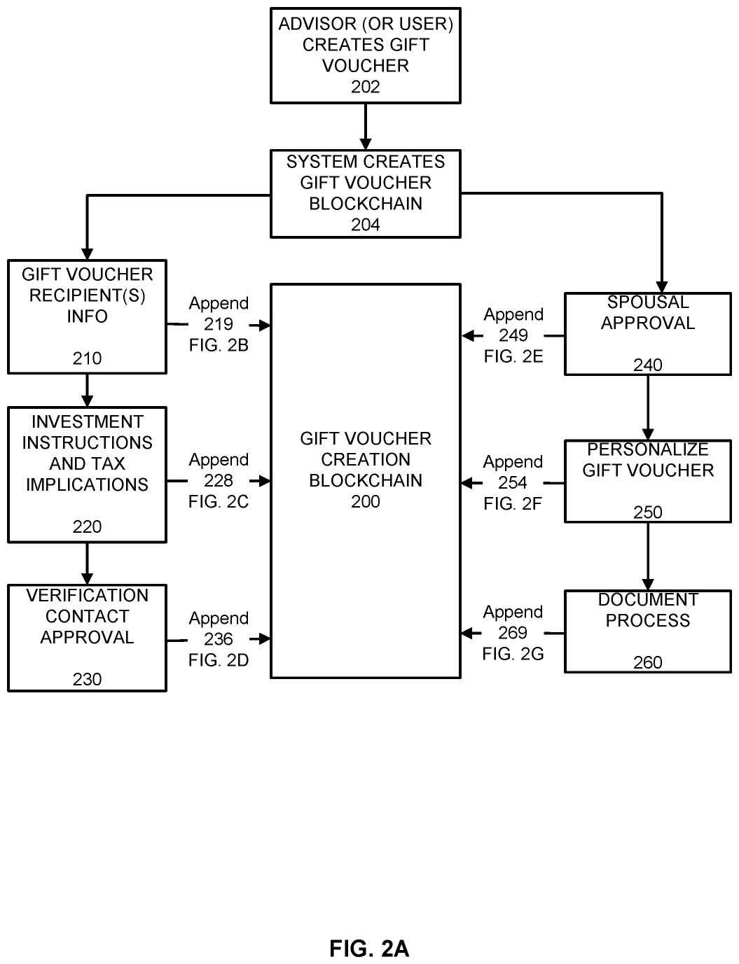

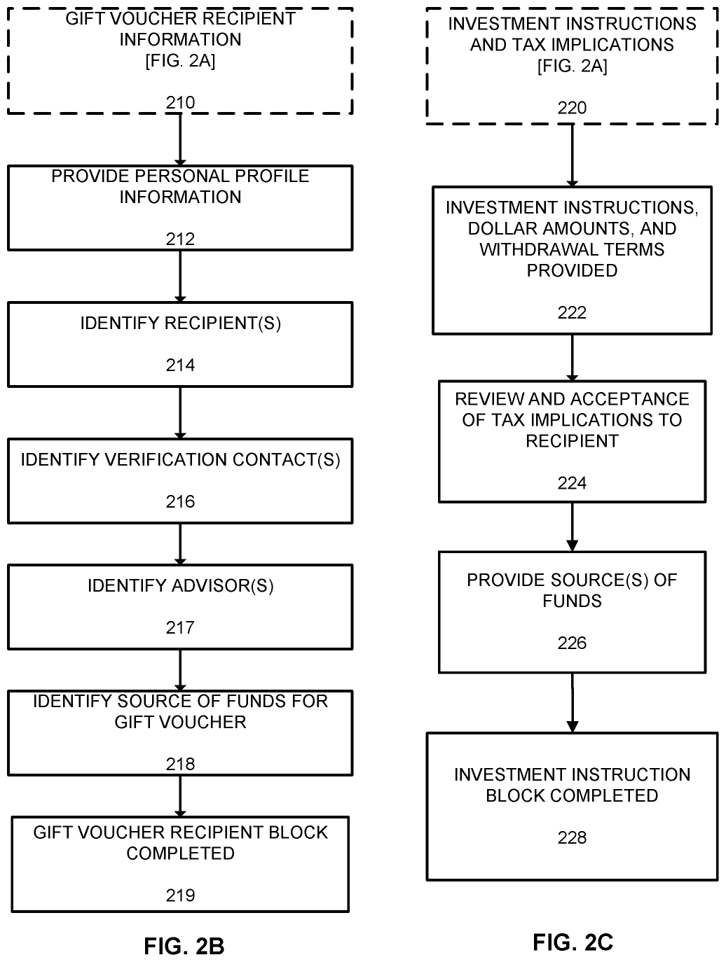

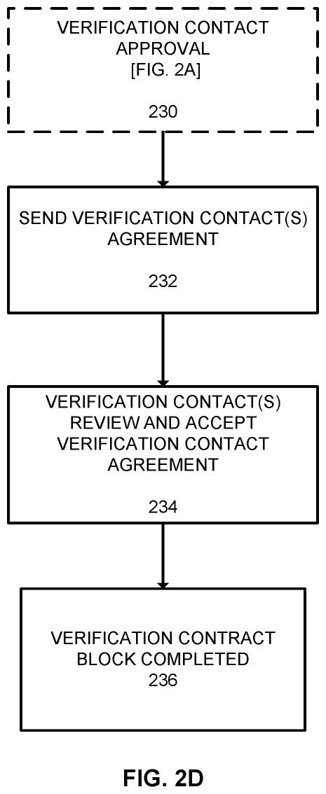

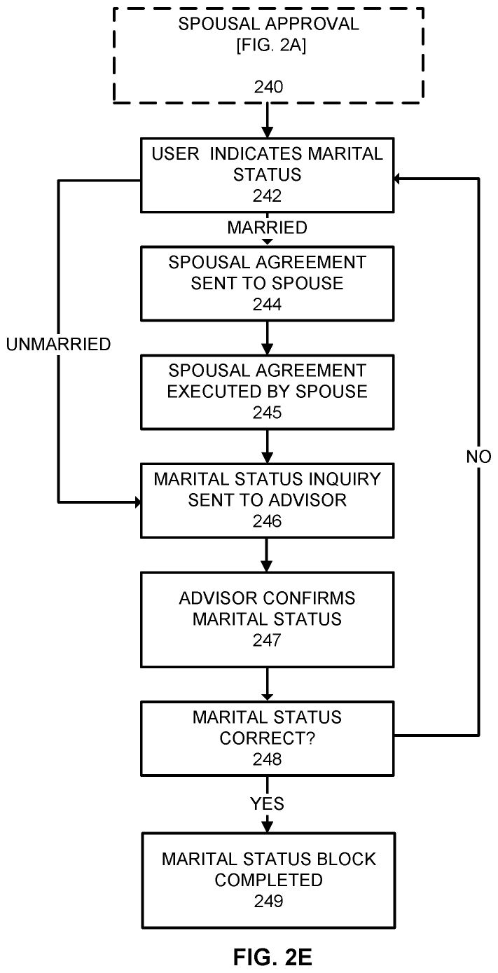

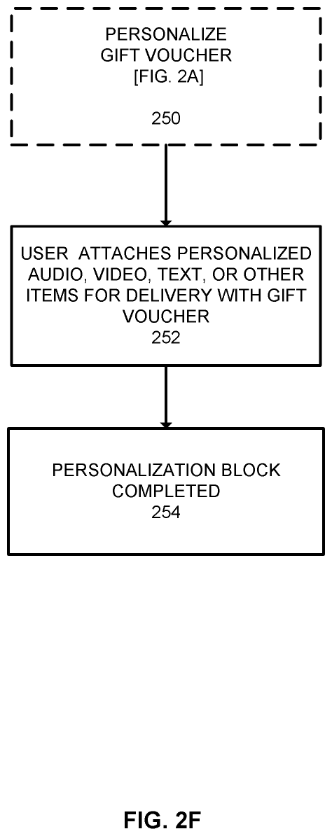

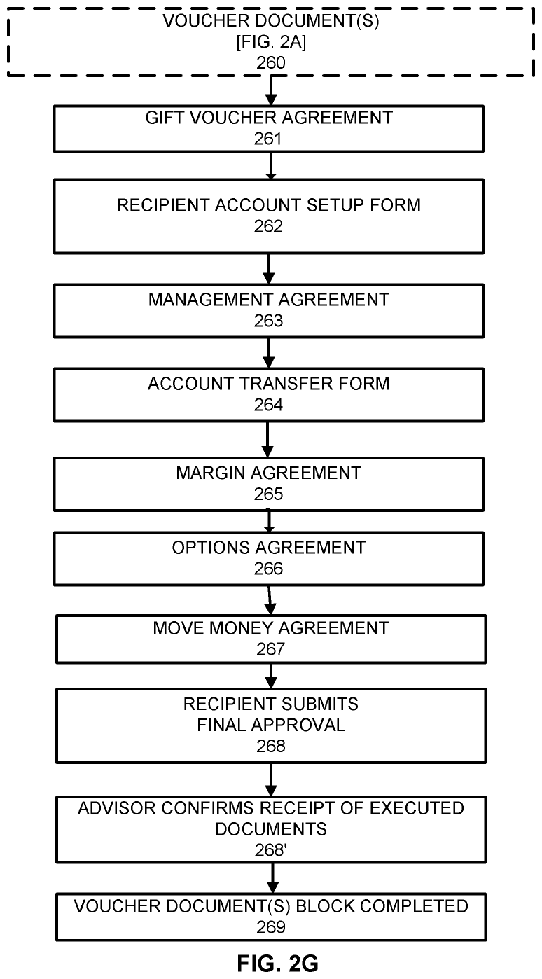

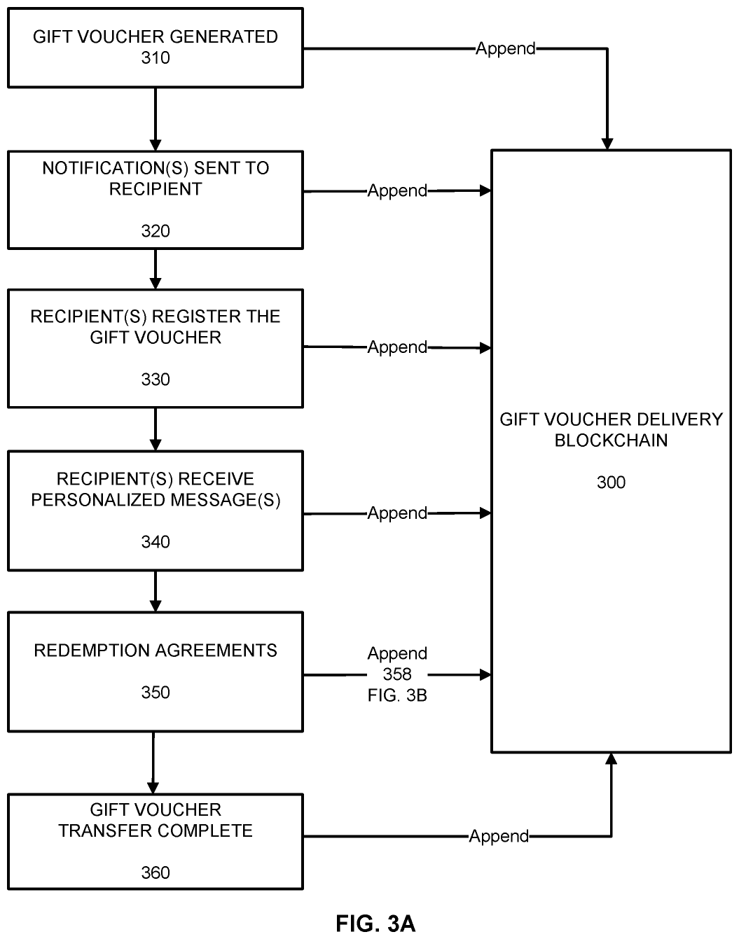

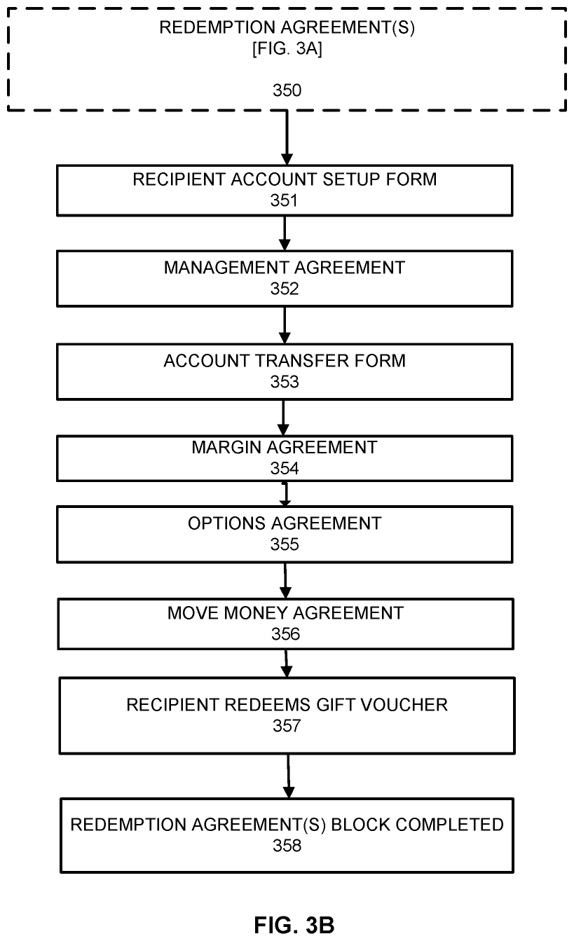

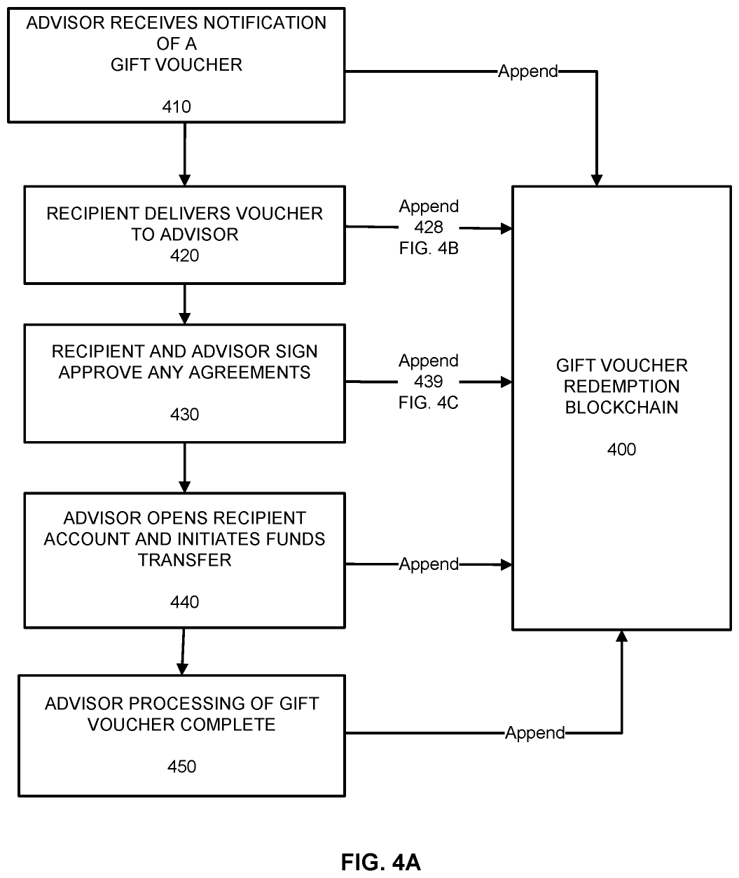

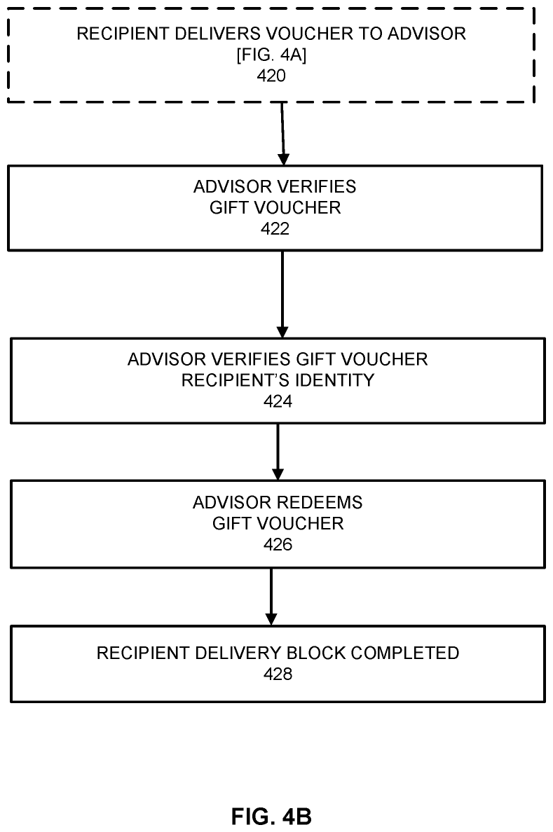

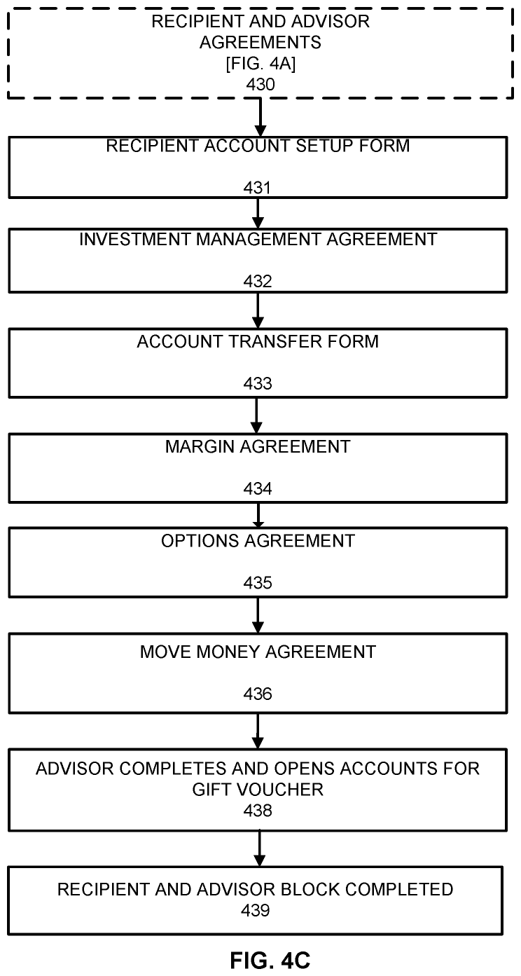

The processes illustrated in FIGS. 2-4 can be part of a computer program product for administering a gift voucher within a blockchain distributed network. The gift voucher process includes, for example, one or more smart contracts between participants of the voucher system, and/or the voucher system controller and voucher system participants, and consists of three separate components, a gift voucher creation process (shown in FIGS. 2A-2G), a gift voucher delivery process (FIGS. 3A-3B) and a gift voucher redemption process (FIGS. 4A-4C). Each of the gift voucher processes are unique with different participants and event records appended to the gift voucher creation blockchain ledger created for the system user and the service provider by the service provider computer program. All three gift voucher components are required to execute fully and in order to consider the gift voucher complete and fully executed. The gift voucher delivery component requires the gift voucher creation to execute fully before it may commence and the gift voucher redemption process and the gift voucher delivery component must be fully executed before it commences delivery. Once the gift voucher is processed, the recipient takes full control of the resulting accounts and the user is no longer involved. Each time data is appended to the blockchain (e.g., a block is created and appended to the blockchain), the blockchain is updated.

Turning now to FIGS. 2A-2G, the gift voucher creation process between the user, the advisor and optionally a trusted contact is illustrated. FIG. 2A is an overview of a gift voucher creation blockchain 200 process. The advisor (or user), using a computer program, creates the gift voucher agreement 202. The gift voucher agreement is then part of a smart contract blockchain with event record requirements of the system user, the recipient, the advisor and the verification contact. The advisor can facilitate the initial creation of the smart contract under the direction of the system user. In another configuration, the system user can begin the voucher creation process directly. The system then creates the gift voucher blockchain 204. One or more additional process steps can be performed as part of the gift voucher blockchain 204, including, for example, providing gift voucher recipient information 210, providing investment instructions and advising of tax implications 220, obtaining verification contact approval 230 for being included as a participant in the gift voucher, obtaining spousal approval 240, personalizing the gift voucher 250, and document process 260. Information from each of the additional processes is appended to the gift voucher creation blockchain 200 as discussed below.

FIG. 2B illustrates a process for obtaining gift voucher recipient information 210. Personal profile information 212 is provided. One or more recipients 214 can also be provided along with one or more verification contacts 216, and one or more advisors 217. For each voucher recipient, a source of funds for the voucher 218 is identified. The system completes a gift voucher block input 219 from the entered data and appends the completed block to the gift voucher creation blockchain 200 in FIG. 2A.

FIG. 2C illustrate a process for providing investment instructions and tax implications 220 which is completed by a user and the advisor and appended to the block. Investment instructions, dollar amounts and withdrawal terms can be specified by the user 222. A summary of tax implications is sent to the recipient 224. Additionally, a summary of the tax implications can be provided to the user. A source of funds can be provided 226. The system completes the investment instruction block input 228 and appends the completed block to the gift voucher creation blockchain 200 in FIG. 2A.

FIG. 2D illustrates verification contact approval option 230. The user provides a verification contact for one or more vouchers. A verification contact agreement is sent to the verification contact 232. The verification contact receives and approves the verification contact agreement 234. Once the verification contact agreement 234 is approved, the verification contact block input 236 is completed and appended to the gift voucher creation blockchain 200 in FIG. 2A. As will be appreciated by those skilled in the art, a user can specify different verification contacts for different recipients, or groups of recipients. Additionally, if the user did not specify a verification contact, no input is created or appended. The verification contact agreement allows the system to contact the verification contact. The verification contact typically does not have authority to make changes to the voucher process established by the user. For example, if a user designates their sister as a trusted administrator, which is a verified contact, when the user passes away, she will receive the list of what the user had going out of the trust. If she is “limited” then she just sees on a “newsfeed” within the app. If she has “full access” then she can push the money or gift icon and see what was or is being sent in detail like dollar amounts. The verification contact sees the “alerts” occurring in the system as part of the or voucher set-up. If the recipient has not obtained the item, then the verification contact can obtain contact information for the recipient and, for example, call the recipient to alert the recipient that they need to log into the system to update contact information or obtain any item that is waiting (including messages, videos and the like. The voucher can be set-up so that any remainder at the end of the life of the trust is transferred to the verification contact at the discretion of the user.

FIG. 2E illustrates a user spousal approval requirement process 240 completed by user and advisor and appended to the blockchain. The user indicates marital status 242, if the user is married, then a spousal agreement is sent to the user's spouse 244, the spousal agreement is then executed by the spouse 245. If the user is unmarried, or the spousal agreement has been executed, a marital status inquiry is sent to the advisor 246. The advisor then confirms the marital status 247 as either married or unmarried. If the marital status is correct 248, then a marital status blockchain input 249 is completed and appended to the gift voucher creation blockchain 200 in FIG. 2A.

As will be appreciated by persons of skill in the art, if it is desirable, the recipients can also be subjected to a spousal agreement process similar to the user spousal approval process disclosed. In addition, or instead of sending the marital inquiry to the advisor, the marital inquiry can be sent to a trusted third person such as the verification contact.

FIG. 2F illustrates user gift voucher personalization optional requirements completed by user and appended to the gift voucher creation blockchain 200. If the user does not create and attach one or more personalized messages and other media the personalization blockchain 254 input is not created or appended. The personalize gift voucher 250 process includes the user attaching one or more of a personalized audio, video, text, or other item for delivery to the recipient 252 when the gift voucher is delivered to the recipient. Once the user creates the one or more personalized message, the personalization blockchain input 254 is completed and appended to the gift voucher creation blockchain 200 in FIG. 2A.

FIG. 2G shows a document process 260 required for the recipient to successfully redeem the gift voucher. Documents include one or more of a gift voucher agreement 261, a recipient account set-up form 262, a management agreement 263, an account transfer form 264, a margin agreement 265, an options agreement 266, and an authorization to move money agreement 267. Each agreement is reviewed and approved electronically by the appropriate party (e.g., user, recipient, etc.). Once the agreements are reviewed and signed, the agreements are submitted for final approval 268. Each event record or block can also contain a scanned facsimile in file format (i.e. pdf or jpg) of a document having a pen on paper signature which is appended in its entirety to the blockchain. The advisor can also confirm receipt 268′. A voucher document blockchain 269 input is then completed and appended to the gift voucher creation blockchain 200 in FIG. 2A.

FIGS. 3A-3B illustrates a gift voucher delivery blockchain 300 process. FIG. 3A shows each delivery action the system executes for the benefit of the recipient. A gift voucher is generated 310. Once the gift voucher is generated, a communication is transmitted to the recipient 320, e.g., via email and/or text. Upon receiving the communication, the gift voucher recipient creates an account and/or registers with the voucher provider service 330. After registering, the gift voucher recipient may receive personalized message 340, as allowed by privacy and personal preferences settings. The gift voucher recipient receives instructions on how to redeem the gift voucher 350. Once the gift voucher recipient redeems the gift voucher 357 (FIG. 3B), the gift voucher transfer is complete 360.

As shown in FIG. 3B, after the gift voucher recipient receives the redemption instructions 350, the participants to the gift voucher receives one or more of the following documents for review and conformation or acceptance: an account set-up form 351, a management agreement 352, an account transfer form 353, a margin agreement 354, an options agreement 355, and a move money agreement 356. Each agreement is reviewed and approved electronically by the appropriate party (e.g., user, recipient, etc.). Once the agreements are reviewed and approved, the gift voucher transfer is complete 370. Each step of reviewing and approving any agreements provided is recorded as a block which is appended to the gift voucher blockchain.

In some configurations, upon receiving a communication, e.g., an email and/or text notification(s), the recipient can download a mobile app through which registration can be completed.

FIGS. 4A-4C illustrate a gift voucher redemption blockchain 400 for a gift redemption process for one or more of the participants, e.g., advisor, recipient and verification contact. As shown in FIG. 4A the advisor can receive notification of a gift voucher 410. Once the gift voucher recipient delivers the gift voucher to the advisor 420, the gift voucher participants exchange, review and enter into agreements 430. Entering into the agreements can be electronically, via smart contracts, or by submitting documents with signatures. Once the agreements are in place the advisor opens one or more accounts for the gift voucher recipient and initiates a transfer of funds from a source 440. Once the funds are transferred, the gift voucher redemption process is complete 450.

Turning to FIG. 4B, the steps for the recipient delivering the voucher to the advisor 420, can also include the steps of the advisor verifying the gift voucher 422, the advisor verifying the recipient's identity 424, and the advisor redeeming the gift voucher 426. Once the recipient delivery block 428 is completed, the block is appended to the gift voucher redemption blockchain 400 in FIG. 4A.

FIG. 4C illustrates additional steps for the review and entering into agreement 430. The gift voucher participants receive one or more of the following documents for review and confirmation or acceptance: an account set-up form 431, an investment management agreement 432, an account transfer form 433, a margin agreement 434, an options agreement 435, and a move money agreement 436. Once the gift voucher recipient has reviewed and approved any required form or agreement, the advisor redeems the gift voucher for benefit of the gift voucher recipient's newly opened account 438 and the transfer is complete. A recipient and advisor block is created 439 and appended to the gift voucher redemption blockchain 400.

The system is also configurable to provide a news feed to each participant. The newsfeed advises of upcoming actions and provides for a regular request for update (e.g., annual update request). Alerts and notifications can be provided via the system newsfeed, via text message, via push notification, via email, or any other suitable available mechanism.

### IV. Coaching Voucher System Overview

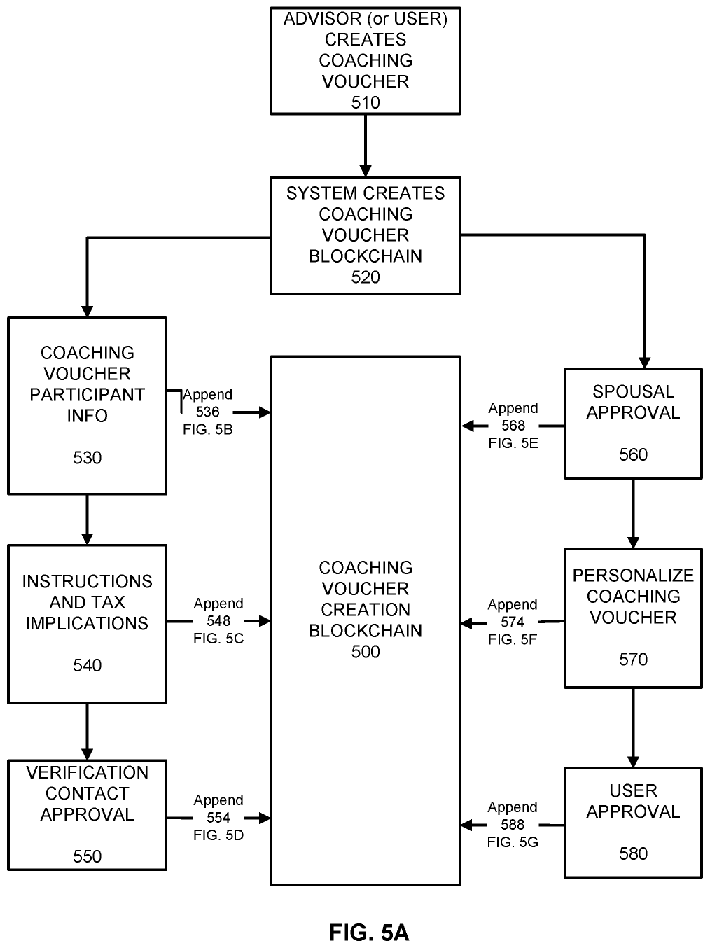

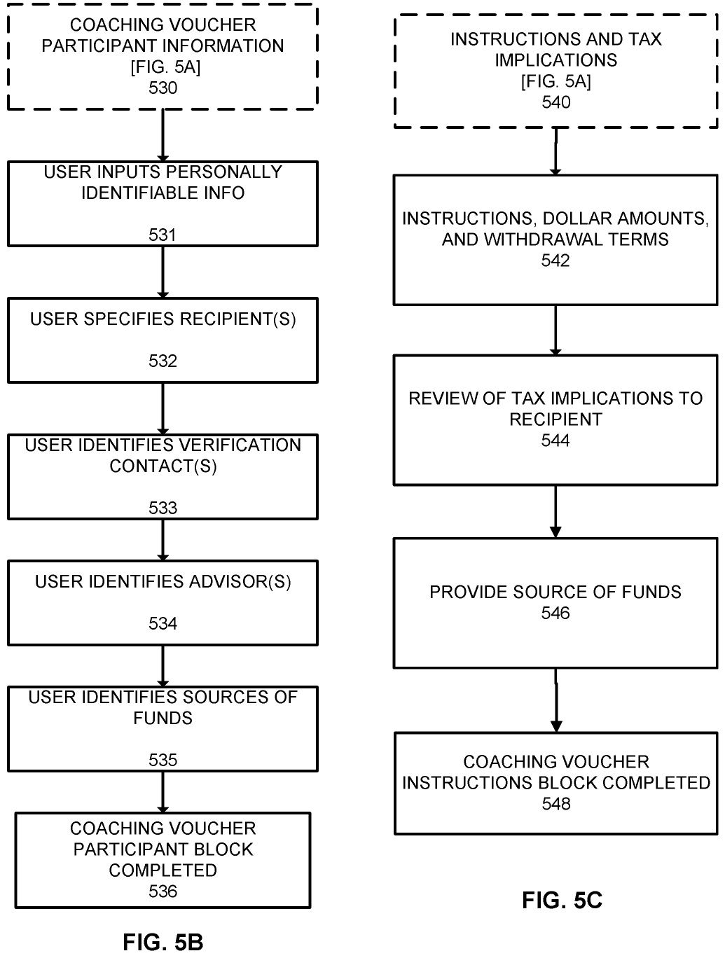

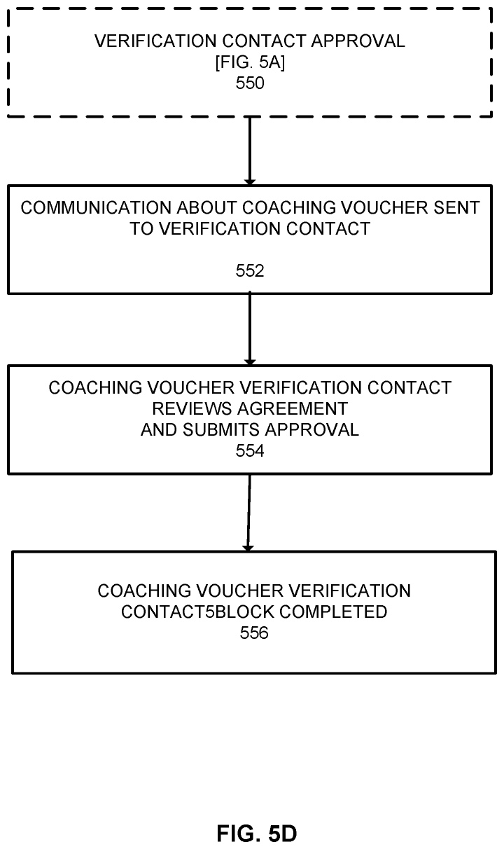

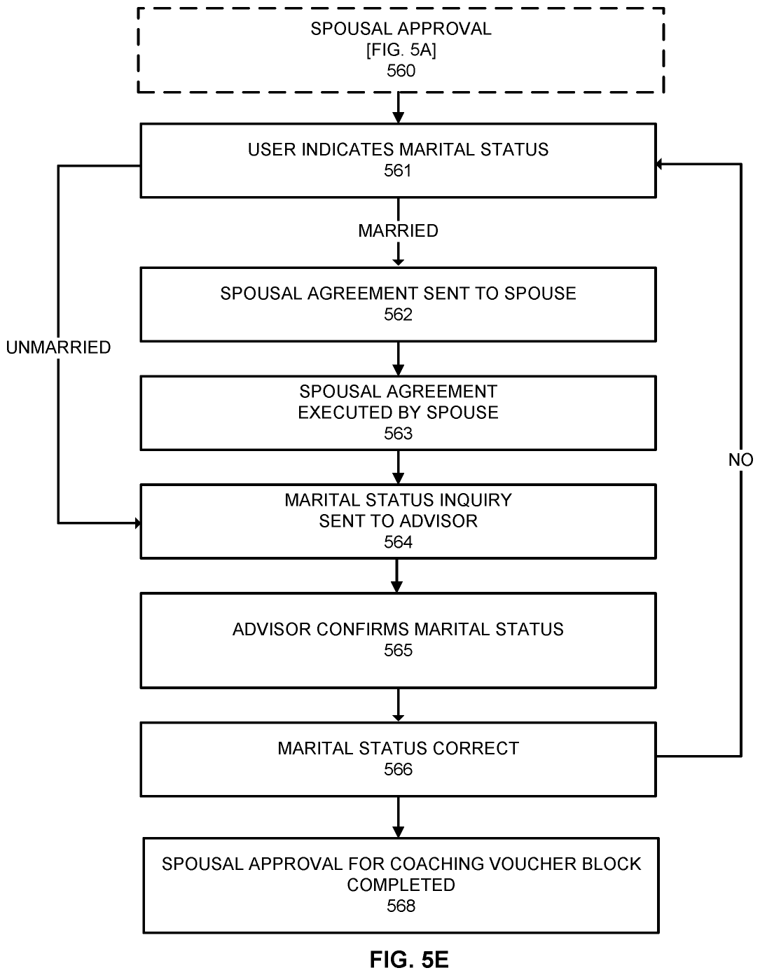

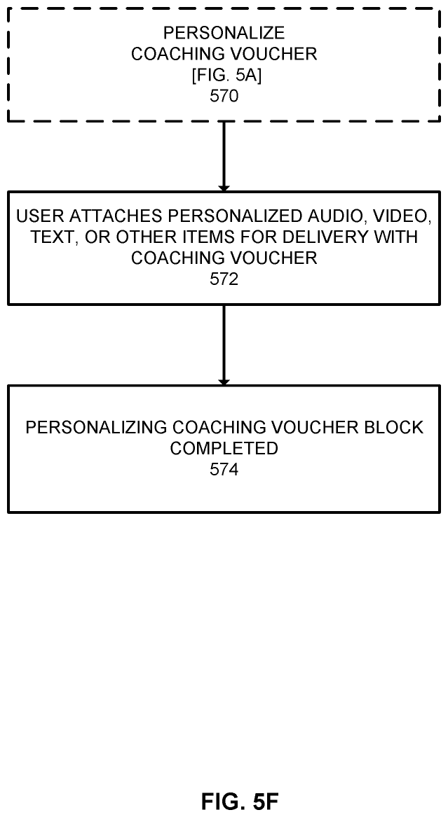

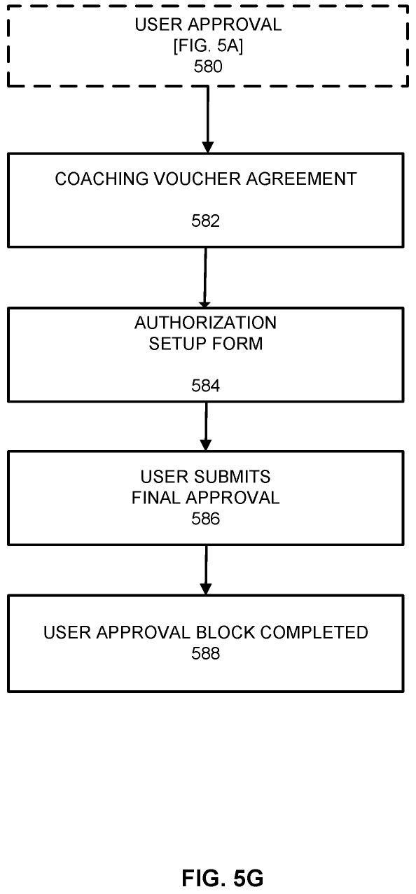

The processes illustrated in FIGS. 5-8 can be part of a computer program product for administering a coaching voucher within a blockchain distributed network. The coaching voucher system has many components that are similar to, or identical to, the gift voucher system. However, with the coaching voucher, the user continues to own the account at least during the coaching process. The voucher recipient only has the ability to provide instructions for the account for at least an initial period of time. The instructions from the recipient can be overridden by the user since the user maintains ownership of the account. After the passage of time, or upon a qualifying event (such as death), the account can then transfer from the user to full ownership by the recipient.

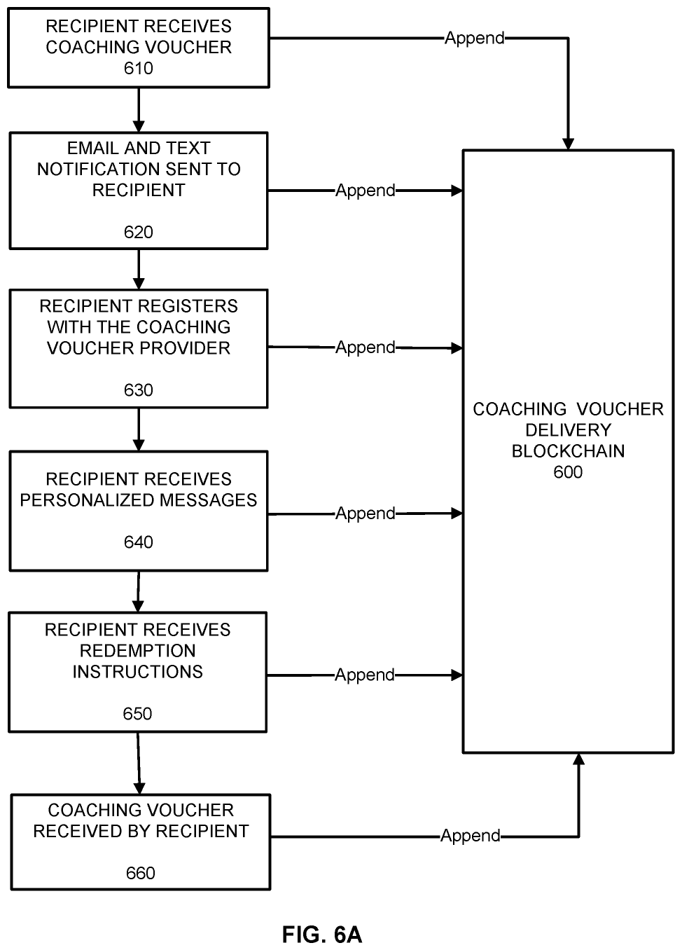

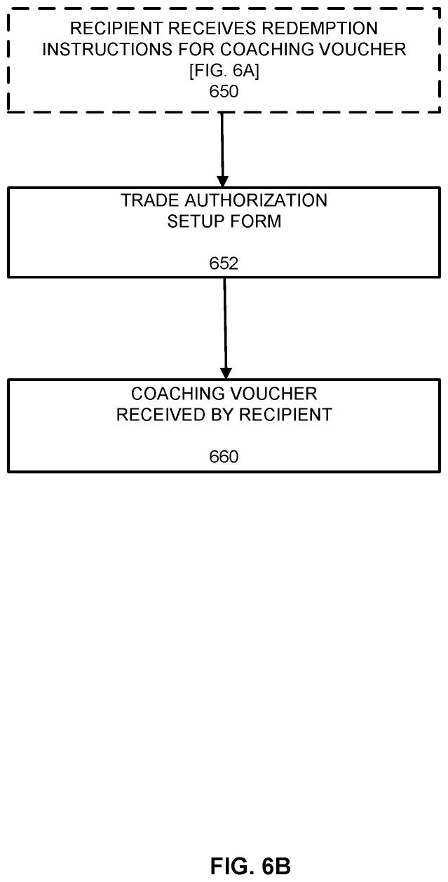

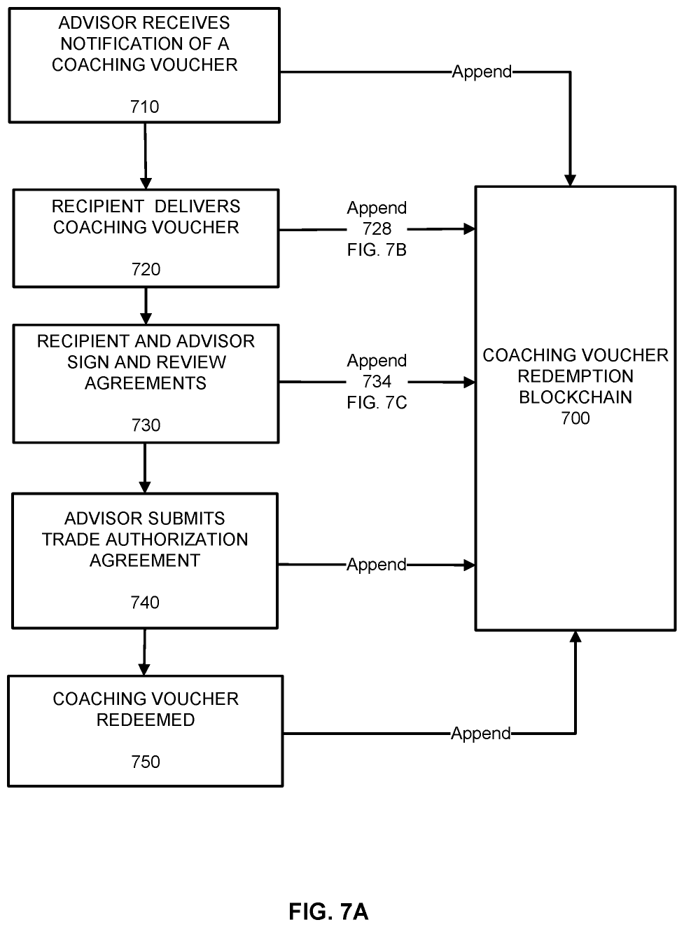

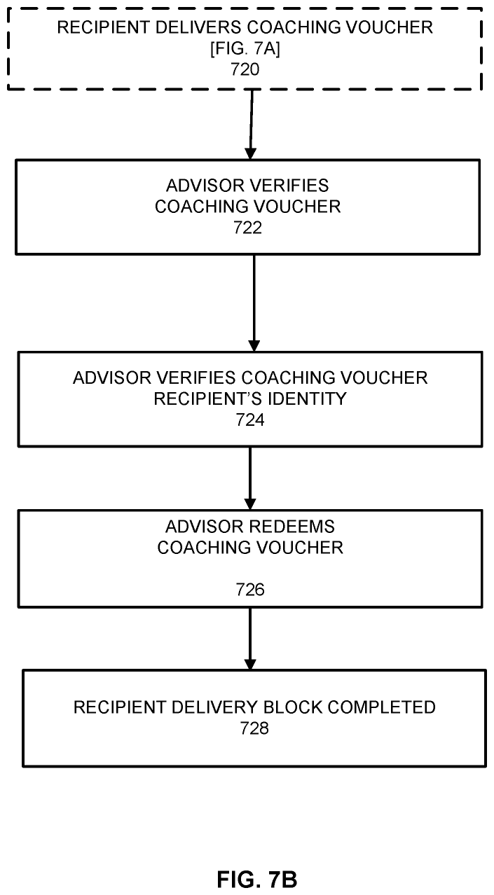

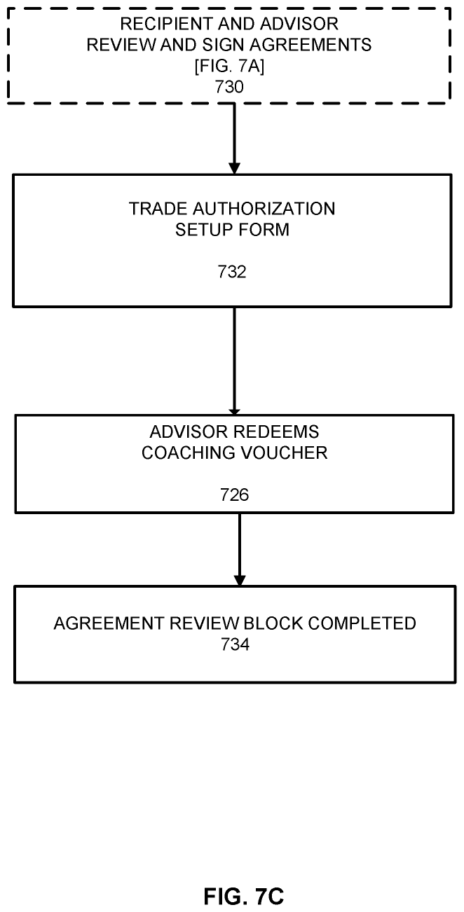

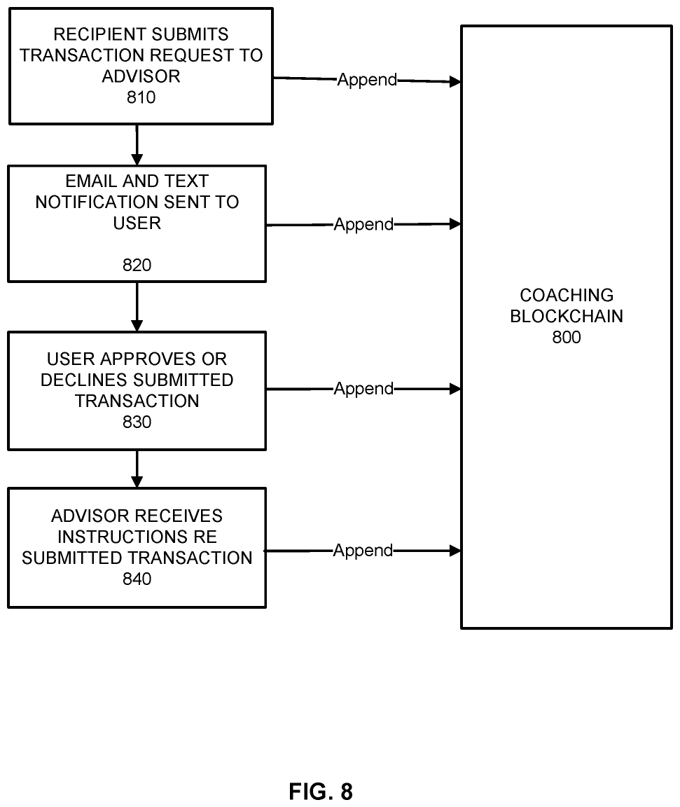

The coaching voucher consists of three separate components: a coaching voucher creation module (shown in FIGS. 5A-5G), a coaching voucher delivery module (FIGS. 6A-6B) and a coaching voucher redemption module (FIGS. 7A-7C). Each of the components have with different participants and event records which are appended to the coaching voucher blockchain ledger. All three components are required to be executed fully in sequence in order to consider the coaching voucher complete and fully executed. Once the coaching voucher is in places, actual coaching of the recipient occurs as detailed in FIG. 8.

FIGS. 5A-5G illustrate the coaching voucher creation module between the user, the advisor and optionally a verification contact. FIG. 5A illustrates the coaching voucher creation blockchain 500 process. The advisor or user uses a computer program to create the coaching voucher agreement 510. The system creates a coaching voucher blockchain 520. The coaching voucher agreement is a blockchain with event record requirements of the system user, the recipient, the advisor and the verification contact. The advisor can facilitate the initial creation of the coaching voucher under the direction of the user. During the process of creating the coaching voucher, coaching participant information is provided 530, instructions are provided regarding tax implications 540, verification contact information is provided and approved 550, spousal approval, if needed, is obtained 560, the coaching voucher is personalized 570, and the user approves the final coaching voucher 580.

FIG. 5B illustrates steps for the coaching voucher participation information step 530. As an initial process personally identifiable information 531 for the user is provided. Once a user profile is set-up with personally identifiable information, one or more recipients 532 can be specified to receive the coaching voucher. One or more verification contacts 533 can also be identified. For example, different recipients may have different verification contacts. One or more advisors 534 is also identified. Typically, one advisor is identified per coaching voucher recipient. However, the system is not limited to one advisor per recipient or user. One or more sources of funds is also identified for each of the recipients 535. Once the information is provided, the coaching voucher participant block 536 is completed and appended to the coaching voucher creation blockchain 500 as shown in FIG. 5A.

FIG. 5C illustrates investment instructions and tax implications 540 completed by user and advisor and appended to the blockchain. In a first process, instructions, dollar amounts and withdrawal terms are provided 542. The instructions and withdrawal terms outline the conditions under which the recipient can instruct or withdraw funds from the account owned by the user. The recipient will also be required to review tax implications for the money funding the account 544. The recipient may be provided with the source of funds 546. Once the coaching voucher instruction block 548 is completed, the block is appended to the coaching voucher creation blockchain 500.

FIG. 5D shows a verification contact approval 550 process. This process is optional, and provides for the verification contact to receive a communication about the coaching voucher 552 and then to review agreements and submit approval of the agreements 554. Once the coaching voucher verification contact block 556 is complete, the block is appended to the coaching voucher creation blockchain 500. If the user does not specify a verification contact, a block for this process is not appended.

FIG. 5E illustrates a spousal approval 560 process for completion by the user and advisor and appended to the blockchain. As with the spousal approval illustrated in FIG. 2E a user spousal approval requirement process 560 is completed by user and advisor and appended to the blockchain. The user indicates marital status 561, if the user is married, then a spousal agreement is sent to the user's spouse 562, the spousal agreement is then executed by the spouse 563. If the user is unmarried, or the spousal agreement has been executed, a marital status inquiry is sent to the advisor 564. The advisor then confirms the marital status 565 as either married or unmarried. If the marital status is correct 566, then the spousal approval for coaching voucher block 568 is completed and appended to the coaching voucher creation blockchain 500 in FIG. 5A.

FIG. 5F shows user coaching voucher personalization 570 optional requirements completed by user and appended to the blockchain. Similar to the process shown in FIG. 2F a coaching voucher personalization can be completed by user and appended to the blockchain. If the user does not create and attach one or more personalized messages and other media the block is not created or appended. The personalize coaching voucher 570 process includes the user attaching one or more of a personalized audio, video, text, or other item for delivery to the recipient 572 when the coaching voucher is delivered to the recipient. Once the user creates the one or more personalized message, personalizing coaching voucher block 574 is completed and appended to the coaching voucher creation blockchain 500 in FIG. 5A.

FIG. 5G illustrates a user review and approval of the coaching voucher 580 and any other documents required for the recipient to successfully redeem the coaching voucher in the future. Each block can contain a document in a scanned format (i.e. pdf or jpg) which is appended in its entirety to a block. Alternatively, the user can sign electronically. In securing user approval, the user may review and sign one or more of: coaching voucher agreement 582, and authorization set-up form 584. Once the agreements are in place the user submits a final approval 586 and the user approval block is completed 588 and appended to the coaching voucher creation blockchain 500 in FIG. 5A.

FIGS. 6A-6B shows the coaching voucher delivery blockchain 600 process of the recipient receiving the coaching voucher. FIG. 6A shows a plurality of delivery actions the system executes and appends to the blockchain for during the coaching voucher delivery blockchain process, As a first step, the recipient receives a coaching voucher 610, e.g. an electronic voucher such as an email and/or text notification is sent to the recipient 620. The recipient then registers with the system 630. Registration can include downloading a mobile app or accessing a website. The recipient can receive personalized messages 640 from the user and other media as part of the coaching voucher. The recipient also receives redemption instructions 650 and legal documents. As each action occurs, a block is appended to the coaching voucher delivery blockchain 600.

FIG. 6B illustrates the redemption instructions 650 and legal documents process in FIG. 6A. During the redemption process a trade authorization set-up form 652 is reviewed and approved. Once all the forms are reviewed and approved, the coaching voucher is received by the recipient 660 and appended to the coaching voucher delivery blockchain 600 in FIG. 6A.

FIGS. 7A-7C shows a coaching voucher redemption blockchain 700 for the advisor, recipient and optionally a verification contact. As shown in FIG. 7A the advisor receives the coaching voucher 710 (e.g., the recipient delivers the coaching voucher 720). The steps from the delivery of the coaching voucher are appended to the coaching voucher redemption blockchain 700. The recipient and the advisor sign and review agreements 730 related to the coaching voucher. Entering into the agreements can be electronically, via smart contracts, or by submitting documents with signatures. The advisor submits trade authorization agreement 740 which is appended to the coaching voucher redemption blockchain 700 in FIG. 7A. Each agreement is reviewed and approved electronically by the appropriate party (e.g., user, recipient, etc.), after which the coaching voucher is redeemed 750. As will be appreciated by those skilled in the art, the redemption process can also include notification of the verification contact of the coaching voucher redemption process. Involving the verification contact can include steps and blockchain additions for verifying the identity of the recipient and/or advisor.

Turning to FIG. 7B, when the recipient delivers the coaching voucher 720. The advisor verifies the coaching voucher 722 and then verifies the recipient's identity 724. As noted above, identity verification can include requesting the verification contact to confirm the identity of the recipient. Once the advisor verifies the recipient's identity and completes requested documentation, the advisor redeems the coaching voucher 726 and the recipient delivery blockchain input 728 is completed and appended to the coaching voucher redemption blockchain 700 in FIG. 7A.

FIG. 7C illustrates additional process for the recipient and the advisor to review and complete agreements 730, e.g. sign, approve or authorize agreements. Entering into the agreements can be electronically, via smart contracts, or by submitting documents with signatures. Completing agreements includes, for example, a trade authorization set-up form 732 review and approval process. Once the agreement review block is completed 734 the block is appended to the coaching voucher redemption blockchain 700 in FIG. 7A.

Once the coaching voucher is redeemed and the accounts are set-up, the system can be configured to accommodate a coaching process occurs. The coaching process can occur with or without a blockchain record. Additionally, the coaching the blockchain process for coaching can occur within the disclosed system or as part of a separate system. FIG. 8 illustrates a coaching transaction blockchain 800. The coaching transaction can occur repeatedly during the duration of coaching. During coaching, the recipient submits a transaction request to the advisor 810. For example, instructions to buy 100 shares of a particular stock. A notification, such as email or text, is sent to the user 820 advising the user of the proposed action. The user then approves or declines the submitted transaction 830. If the user approves the instructions, then the instructions are provided to the advisor 840 for completion of the transaction. Each step of the process is appended to a coaching transaction blockchain 800. An additional process can also occur whereby the user responds to the recipient to explain why the proposed transaction was approved or declined.

In another configuration of the coaching voucher shown in FIG. 8, the recipient submits a transaction request to the advisor. A notification or communication, such as email or text, is sent to the advisor requesting the proposed action. The advisor then approves or declines the submitted transaction. If the advisor approves the transaction, then the transaction is completed. Each step of the process is appended to a coaching blockchain. An additional process can also occur whereby the advisor responds to the recipient to explain why the proposed transaction was approved or declined.

The processes illustrated in FIGS. 2-8 can be part of a computer program product for administering a voucher within a blockchain distributed network is disclosed. The computer program product for administering a voucher comprises at least one non-transitory computer-readable medium having computer-readable program code portions embodied therein, the computer-readable program code portions comprising: an executable portion configured to receive a request from a user utilizing a node to access the blockchain, wherein the request includes received authentication credentials, wherein the blockchain network comprises a distributed network of nodes managed by one or more entities, wherein nodes from the distributed network of nodes are operatively coupled to each other, have at least a portion of a ledger, and share information on the ledger through electronic communication, and wherein the received authentication credentials comprises user authentication credentials and node authentication credentials; an executable portion configured to compare the received authentication credentials with stored authentication credentials for the user and the node; an executable portion configured to allow the user to access the blockchain distributed network when the received authentication credentials meet the stored authentication credentials for the user and the node; an executable portion configured to determine one or more types of actions that the user is allowed to, or prevented from, taking based on the comparison of the received authentication credentials with the stored authentication credentials; an executable portion configured to receive an indication that the user took an action for an event within the blockchain, wherein the action occurred on the node from the distributed network of nodes, and wherein the action is validating the event using event information on the ledger of the node from the distributed network of nodes of the blockchain, storing the event information for the event on the ledger of the node from the distributed network of nodes of the blockchain, or disseminating the event information for the event on the ledger of the node to one or more other nodes of the distributed network of nodes of the blockchain; an executable portion configured to determine limits, wherein the limits comprise one or more user limits, one or more node limits, one or more entity limits, one or more event limits, and one or more action limits; an executable portion configured to compare the action taken and the user, the node, an entity associated with the user, and the event associated with the action to the limits, including the one or more user limits, the one or more node limits, the one or more entity limits, the one or more event limits, and the one or more action limits; and an executable portion configured to allow or deny the action based on the determination of the one or more types of actions that the user is allowed to, or prevented from, taking based on the comparison of the received authentication credentials with the stored authentication credentials and based on the comparison of the action and the user, the node, the entity, and the event associated with the action to the limits.

Identity verification on the current user who operates the account is performed to effectively control the risk of fraud with respect to the account. Furthermore, operation permission of an authorized user can be specified to allocate permission for the account. In addition, proxy permission information can be stored in the blockchain, and therefore it can be effectively ensured that the permission is trusted, thereby alleviating problems associated with a centralized node and access costs.

In an implementation, when receiving a permission query message from the system, the server can communicate with a first client, to verify the identity of the current user. For example, the server can send permission query task information to the service system, and the permission query task information instructs to invoke the first client. As such, the service system can invoke the first client based on the permission query task information. For example, the service system can prompt the current user to scan a code by using the end-user device of the current user to start the first client or by submitting a biometric (such as a fingerprint). Alternatively, the system can push a message, such as a text, for starting the first client to the end-user device of the current user, and then starts the first client based on acknowledgement input of the current user.

The verification information can include an authorization code. For example, the server can send an authorization instruction to the first client. The authorization instruction can be used to request the authorization code. For example, the authorization instruction can include a server time, an identifier of a channel, a challenge code, and a quantity of bits of the authorization code. The server then can receive the authorization code from the first client. The authorization code can be generated by the first client based on the authorization instruction and a client token. The channel can represent the use of the authorization code. For example, in the present specification, the channel can be used to represent that the authorization code is used to verify an identity. The challenge code can be a random code for ensuring security of a channel for sending the authorization instruction, for example, is used to place a request for replay and tampering.

For example, the authorization code can be generated based on an HMAC-based one-time password (HOTP) algorithm. For example, the authorization code can be generated by using the HOTP algorithm based on the client token, the identifier of the channel, the server time, the quantity of bits of the authorization code, and a value of the challenge code.

### V. Examples

### Example 1

In a first example, the user enters into an agreement (i.e. contracts) with the voucher system provider to administer a voucher. The funds for the voucher are distributed from the accounts identified by the user during the user set-up process to the voucher system. The voucher is transmitted to the advisor identified by the user for the benefit of the voucher recipient.

The voucher recipient can be a third-party beneficiary to the agreement between the user and the voucher system provider. In order to receive the benefit of the agreement between the user and the voucher system provider, the voucher recipient can be required to open an investment account for the funds with the advisor identified and maintain the account for the period of time specified in the agreement between the user and the voucher system provider. The user can include a provision that requires the funds to revert back to the user if the recipient does not honor the terms of the voucher.

### Example 2

An example of the investment gift voucher is the system user has a deposit account with funds (assets). The user enters into an agreement with the voucher system provider to administer a gift voucher. The funds for the gift voucher will be distributed directly to a new investment account with assistance from advisor and a verification contact for the benefit of the recipient.

The recipient can be a third-party to the agreement between the user and voucher system provider. In order to receive the benefit of the agreement between the user and the voucher system provider, the recipient can be required to open an investment account for the funds with the advisor identified and maintain the account for the period of time specified in the agreement between the user and the voucher system provider. The advisor is a third-party to the agreement between the user and voucher system provider. In order to facilitate the benefit of the agreement to the recipient, the advisor is required to set up an investment account for the recipient, transfer user funds to the new investment account and follow specific user investment instructions while advising the recipient investing of those funds.

The trusted contact is a third-party to the agreement between the user and voucher system provider. In order to facilitate the benefit of the agreement to the recipient, the trusted contact acts as an emergency contact should the other third parties encounter issues communicating with each other while executing the agreement between the system user and voucher system provider.

### Example 3

An example of the coaching voucher is the system user has an investment account with funds, securities and or other assets. The user enters into an agreement with voucher system provider to administer a coaching voucher. Trading authorization on the investment account will be granted with assistance from an advisor and trusted contact for the benefit of the recipient. The recipient is a third-party to the agreement between the user and voucher system provider. In order to receive the benefit of the agreement between the user and voucher system provider, the recipient is required to execute a trade authorization agreement with the advisor identified for the period of time specified in the agreement between the user and the voucher system provider.

The advisor is a third-party to the agreement between the user and voucher system provider. In order to facilitate the benefit of the agreement to the recipient, the advisor is required to submit the trade authorization agreement and follow specific user investment instructions while advising the recipient trading on the user's investment account.

The trusted contact is a third-party to the agreement between the user and voucher system provider. In order to facilitate the benefit of the agreement to the recipient, the trusted contact acts as an emergency contact should the other third parties encounter issues communicating with each other while executing the agreement between the system user and voucher system provider.

### VI. Computing Environment Overview

The systems and methods according to aspects of the disclosed subject matter may utilize a variety of computer and computing systems, communications devices, networks and/or digital/logic devices for operation. Each may, in turn, be configurable to utilize a suitable computing device that can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as an iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web browser, e.g., to provide access to applications and data and other content located on a website or a webpage of a website.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method that may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at sometimes be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

Additionally, a communication system of the disclosure comprises: a sensor as disclosed; a server computer system; a measurement module on the server computer system for permitting the transmission of a measurement from a detection device over a network; at least one of an API (application program interface) engine connected to at least one of the detection device to create a message about the measurement and transmit the message over an API integrated network to a recipient having a predetermined recipient user name, an SMS (short message service) engine connected to at least one of the system for detecting physiological parameters and the detection device to create an SMS message about the measurement and transmit the SMS message over a network to a recipient device having a predetermined measurement recipient telephone number, and an email engine connected to at least one of the detection device to create an email message about the measurement and transmit the email message over the network to a recipient email having a predetermined recipient email address. Communications capabilities also include the capability to communicate and display relevant performance information to the user, and support both ANT+ and Bluetooth Smart wireless communications. A storing module on the server computer system for storing the measurement in a detection device server database can also be provided. In some system configurations, the detection device is connectable to the server computer system over at least one of a mobile phone network and an Internet network, and a browser on the measurement recipient electronic device is used to retrieve an interface on the server computer system. In still other configurations, the system further comprising: an interface on the server computer system, the interface being retrievable by an application on the mobile device. Additionally, the server computer system can be configured such that it is connectable over a cellular phone network to receive a response from the measurement recipient mobile device. The system can further comprise: a downloadable application residing on the measurement recipient mobile device, the downloadable application transmitting the response and a measurement recipient phone number ID over the cellular phone network to the server computer system, the server computer system utilizing the measurement recipient phone number ID to associate the response with the SMS measurement. Additionally, the system can be configured to comprise: a transmissions module that transmits the measurement over a network other than the cellular phone SMS network to a measurement recipient user computer system, in parallel with the measurement that is sent over the cellular phone SMS network.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed:

1. A system comprising:
at least one hardware processor; and
a memory storing instructions that, when executed by the at least one hardware processor, causes the at least one hardware processor to perform operations in a networked computing environment comprising:
receiving a request to create a voucher from a requestor;
creating a voucher blockchain;
obtaining recipient information from the requestor;
appending the recipient information to a voucher blockchain;
obtaining one or more voucher source information from the requestor;
appending the one or more voucher source information to the voucher blockchain;
obtaining an advisor information from the requestor;
appending the advisor information to the voucher blockchain;
generating the voucher wherein the voucher comprises a control logic configured to control access to the voucher based on obtaining verification of the recipient, instructions from the recipient, and instructions from the advisor and the control logic is executed using the hardware processor configured to receive a first instruction from the recipient to open an account and a second instruction from the advisor to open an account; and
appending the voucher to the voucher blockchain.

2. The system of claim 1 wherein the instructions further comprises one or more of:
obtaining a marital status from the requestor;
obtaining spousal information from the requestor;
obtaining spousal agreement from a spouse;
confirming the marital status;
generating a marital status completion block; and
appending the marital status completion block to the voucher blockchain.

3. The system of claim 1 wherein the instructions further comprises one or more of:
obtaining a personalization input from the requestor for the one or more recipients;
generating a personalization completion block; and
uploading the personalization completion block to the voucher blockchain.

4. The system of claim 1 wherein the instructions further comprises one or more of:
creating a voucher agreement;
creating an account set-up form;
creating a management agreement;
creating an account transfer form;
creating a margin agreement;
creating an options agreement;
creating a money movement agreement;
generating a voucher documents completion block containing the one or more created forms ad agreements; and
appending the voucher documents completion block to the voucher blockchain.

5. The system of claim 4 wherein the system is configured to generate a unique hash value for each of the documents reviewed and signed based on a secure hash algorithm in real time and store each unique hash value on the voucher blockchain.

6. The system of claim 5 wherein the instructions further comprises one or more of:
notifying the recipient of the voucher;
registering the voucher by the recipient;
obtaining an approval of redemption documents from the recipient;
generating a voucher delivery completion block; and
appending the voucher delivery completion block to the voucher blockchain.

7. The system of claim 6 wherein the redemption documents comprise one or more of:
recipient account set-up;
management agreement;
account transfer form;
margin agreement;
options agreement; and
move money agreement.

8. The system of claim 1 wherein the instructions further comprises one or more of:
providing an instruction for a coaching amount;
providing an instruction for coaching terms;
generating a coaching voucher delivery block; and
appending the coaching voucher delivery completion block to the voucher blockchain.

9. The system of claim 8 wherein the instructions further comprises one or more of:
analyzing an instruction from a recipient;
providing the recipient feedback on the instruction;
generating a coaching transaction block and
appending the coaching transaction block to the voucher blockchain.

10. The system of claim 9 wherein the recipient feedback is provided at a plurality of times.

11. The system of claim 1 wherein the instructions further comprises one or more of:
obtaining one or more verification contact information for the recipient; and
appending the verification contact information to the voucher blockchain.

12. A computer-implemented method for account creation in a networked computing environment, the method comprising:
receiving a request to create a voucher from a requestor;
creating a voucher blockchain;
obtaining recipient information from the requestor;
appending the recipient information to a voucher blockchain;
obtaining one or more verification contact information for the recipient;
appending the one or more voucher source information to the voucher blockchain;
obtaining an advisor information from the requestor;
appending the advisor information to the voucher blockchain;
generating the voucher wherein the voucher comprises a control logic configured to control access to the voucher based on obtaining verification of the recipient, instructions from the recipient, and instructions from the advisor and the control logic is executed using the hardware processor configured to receive a first instruction from the recipient to open an account and a second instruction from the advisor to open an account; and
appending the voucher to the voucher blockchain.

13. The computer-implemented method of claim 12 wherein the instructions further comprises one or more of:
obtaining a marital status from the requestor;
obtaining spousal information from the requestor;
obtaining spousal agreement from a spouse;
confirming a marital status; and
uploading a marital status completion block to the blockchain.

14. The computer-implemented method of claim 12 wherein the instructions further comprises one or more of:
obtaining one or more verification contacts for the one or more recipients;
obtaining a verification contact agreement from one or more verification contacts; and
uploading a verification contract completion block to the blockchain.

15. The computer-implemented method of claim 12 wherein the instructions further comprises one or more of:
obtaining a personalization input from the requestor for the one or more recipients; and
uploading a personalization completion block to the blockchain.

16. The computer-implemented method of claim 12 wherein the instructions further comprises one or more of:
creating a voucher agreement;
creating an account set-up form;
creating a management agreement;
creating an account transfer form;
creating a margin agreement;
creating an options agreement;
creating a money movement agreement; and
uploading a voucher documents completion block to the blockchain.

17. The computer-implemented method of claim 16 wherein the instructions further comprises one or more of:
notifying the recipient of the voucher;
registering the voucher by the recipient;
obtaining an approval of redemption documents from the recipient; and
uploading a voucher delivery completion block to the blockchain.

18. The computer-implemented method of claim 17 wherein the redemption documents comprise one or more of:
recipient account set-up;
management agreement;
account transfer form;
margin agreement;
options agreement; and
move money agreement.

19. The computer-implemented method of claim 12 wherein the instructions further comprises one or more of:
providing an instruction for a coaching amount;
providing an instruction for coaching terms; and
uploading a coaching voucher delivery completion block to the blockchain.

20. The computer-implemented method of claim 19 wherein the instructions further comprises one or more of:
analyzing an instruction from a recipient;
providing the recipient feedback on the instruction; and
uploading a coaching transaction block to the blockchain.

21. The computer-implemented method of claim 20 wherein the feedback is provided at a plurality of times.

22. The computer-implemented method of claim 12 wherein the instructions further comprises one or more of:
appending the verification contact information to the voucher blockchain; and
obtaining one or more voucher source information from the requestor.
